(19) United States
(12) Patent Application Publication
(10) Pub. No.: US 2012/0040537 A1
(43) Pub. Date: Feb. 16, 2012

(54) COAXIAL CABLE CONNECTOR WITH RADIO FREQUENCY INTERFERENCE AND GROUNDING SHIELD

(76) Inventor: Donald Andrew Burris, Peoria, AZ (US)

(21) Appl. No.: 13/198,765

(22) Filed: Aug. 5, 2011

Related U.S. Application Data
(60) Provisional application No. 61/372,187, filed on Aug. 10, 2010.

(51) Int. Cl. H01R 9/05; H01R 39/00

(52) U.S. Cl. 439/11; 439/578

(57) ABSTRACT

A radio frequency interference (RFI) and grounding shield for a coaxial cable connector is disclosed. The shield comprises a circular inner segment and at least one arcuately shaped pre-formed cantilevered annular beam attached to the circular inner segment by a joining segment. The at least one pre-formed cantilevered annular beam extends angularly from a plane of the circular inner segment. The at least one pre-formed cantilevered annular beam applies a spring-force to a surface of the surface of a component of the coaxial cable connector establishing an electrically conductive path between the components. The at least one pre-formed cantilevered annular beam comprises an outer surface with a knife-like edge that provides a wiping action of surface oxides on component surfaces of the coaxial cable connector and allows for unrestricted movement when the coaxial cable connector is attached to an equipment connection port of an appliance.

### RELATED APPLICATIONS

This application claims the benefit of priority under 35 U.S.C. §119 of U.S. Provisional Application Ser. No. 61/372,187 filed on Aug. 10, 2010 the content of which is relied upon and incorporated herein by reference in its entirety.

### BACKGROUND

The disclosure relates generally to coaxial cable connectors, and particularly to coaxial cable connectors having a flexible, resilient shield which provides radio frequency interference (RFI) and grounding shielding independent of the tightness of the coaxial cable connector to an appliance equipment connection port, and without restricting the movement of the coupler of the coaxial cable connector when being attached to the appliance equipment connection.

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor; this outer conductor may be in the form of a conductive foil and/or braided sheath. The outer conductor is typically maintained at ground potential to shield the signal transmitted by the center conductor from stray noise, and to maintain a continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector; this outer body of the connector is often fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, or other appliance, it is important to achieve a reliable electrical connection between the outer conductor of the coaxial cable and the outer conductor of the appliance terminal. Typically, this goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

With the increased use of self-install kits provided to home owners by some CATV system operators has come a rise in customer complaints due to poor picture quality in video systems and/or poor data performance in computer/internet systems. Additionally, CATV system operators have found upstream data problems induced by entrance of unwanted RF signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired radio frequency (“RF”) signals where RF energy from an external source or sources may enter the connector/cable arrangement causing a signal to noise ratio problem resulting in an unacceptable picture or data performance. Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

As mentioned above, the coupler is rotatably secured about the head of the tubular post. The head of the tubular post usually includes an enlarged shoulder, and the coupler typically includes an inwardly-directed flange for extending over and around the shoulder of the tubular post. In order not to interfere with free rotation of the coupler, manufacturers of such F-style connectors routinely make the outer diameter of the shoulder (at the head of the tubular post) of smaller dimension than the inner diameter of the central bore of the coupler. Likewise, manufacturers routinely make the inner diameter of the inwardly-directed flange of the coupler of larger dimension than the outer diameter of the non-shoulder portion of the tubular post, again to avoid interference with rotation of the coupler relative to the tubular post. In a loose connection system, wherein the coupler of the coaxial connector is not drawn tightly to the appliance port connector, an alternate ground path may fortuitously result from contact between the coupler and the tubular post, particularly if the coupler is not centered over, and axially aligned with, the tubular post. However, this alternate ground path is not stable, and can be disrupted as a result of vibrations, movement of the appliance, movement of the cable, or the like.

Alternatively, there are some cases in which such an alternate ground path is provided by fortuitous contact between the coupler and the outer body of the coaxial connector, provided that the outer body is formed from conductive material. This alternate ground path is similarly unstable, and may be interrupted by relative movement between the appliance and the cable, or by vibrations. Moreover, this alternate ground path does not exist at all if the outer body of the coaxial connector is constructed of non-conductive material. Such unstable ground paths can give rise to intermittent failures that are costly and time-consuming to diagnose.

### SUMMARY OF THE DETAILED DESCRIPTION

One embodiment includes a radio frequency interference (RFI) and grounding shield for a coaxial cable connector. The shield comprises a circular inner segment and at least one arcuately shaped pre-formed cantilevered annular beam attached to the circular inner segment by a joining segment. The at least one pre-formed cantilevered annular beam extends angularly from a plane of the circular inner segment. The at least one pre-formed cantilevered annular beam applies a spring-force to a surface of a component of the coaxial cable connector establishing an electrically conductive path between the components. The at least one pre-formed cantilevered annular beam comprises an outer surface with a knife-like edge that provides a wiping action of surface oxides on component surface of the coaxial cable connector and allows for unrestricted movement when the coaxial cable connector is attached to an appliance equipment connection port of an appliance.

A further embodiment includes a coaxial cable connector comprising a tubular post, a coupler, a body and a shield. The shield provides an electrically conductive path between the post, the coupler and the body providing a shield against RF ingress. The coaxial cable connector couples a prepared end of a coaxial cable to a threaded female equipment port. The tubular post has a first end adapted to be inserted into the prepared end of the coaxial cable between the dielectric material and the outer conductor thereof. The coupler is rotatably attached over a second end of the tubular post. The coaxial cable connector includes a central bore, at least a portion of which is threaded for engaging the female equipment port. The body extends about the first end of the tubular post for receiving the outer conductor, and preferably the cable jacket, of the coaxial cable.

A resilient, electrically-conductive shield is disposed between the tubular post and the coupler. This shield engages both the tubular post and the coupler for providing an electrically-conductive path therebetween, but without noticeably restricting rotation of the coupler relative to the tubular post. The shield may be generally circular and includes a plurality of pre-formed flexible annular cantilevered beams. The tubular post comprises an enlarged shoulder extending inside the coupler with a first rearward facing annular shoulder and a stepped diameter leading to a second rearward facing annular shoulder. The coupler comprises a forward facing annular surface, a through-bore and a rearward facing annular surface. The body at least partially comprises a face, a through bore and an external annular surface. The shield is at least partially disposed between the annular shoulder of the post and face of the body. The pre-formed flexible cantilevered annular beams of the shield are at least partially disposed against the rearward facing annular surface of the coupler. The shield is resilient relative to the longitudinal axis of the connector and maintains an arcuately increased surface of sliding electrical contact between shield and the rearward facing annular surface of the coupler. At the same time the shield is firmly captured and grounded between the body and the tubular post providing electrical and mechanical communication between the coupler, body and tubular post while allowing smooth and easy rotation of the coupler. The coaxial cable connector may also include a sealing ring seated within the coupler for rotatably engaging the body member to form a seal therebetween.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross sectional view of an embodiment of a type of a coaxial connector with a shield as disclosed herein;

FIG. 1A is a detail section of a portion of FIG. 1;

FIG. 2 is a front schematic view of the shield utilized in the connectors of FIG. 1;

FIG. 2A is a side cross sectional view of the shield shown in FIG. 2;

FIG. 3 is a perspective view of the shield utilized in the connectors of FIG. 2;

FIG. 4 is a cross sectional view of the coaxial connector of FIG. 1 with a coaxial cable disposed therein;

FIG. 5 is a cross sectional view of an embodiment of another type of a coaxial connector with the shield as shown in FIG. 2 with a coaxial cable disposed therein; and

FIG. 6 is a cross sectional view of an embodiment of another type of a coaxial connector with the shield as shown in FIG. 2 with a coaxial cable disposed therein.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Coaxial cable connectors are used to couple a prepared end of a coaxial cable to a threaded female equipment connection port of an appliance. The coaxial cable connector may have a post or may be postless. In both cases though, in addition to providing an electrical and mechanical connection between the conductor of the coaxial connector and the conductor of the female equipment connection port, the coaxial cable connector provides a ground path from the braided sheath of the coaxial cable to the equipment connection port. Maintaining a stable ground path protects against the ingress of undesired radio frequency (“RF”) signals which may degrade performance of the appliance. This is especially applicable when the coaxial cable connector is loosened from the equipment connection port, either due to not being tightened upon initial installation or due to becoming loose after installation.

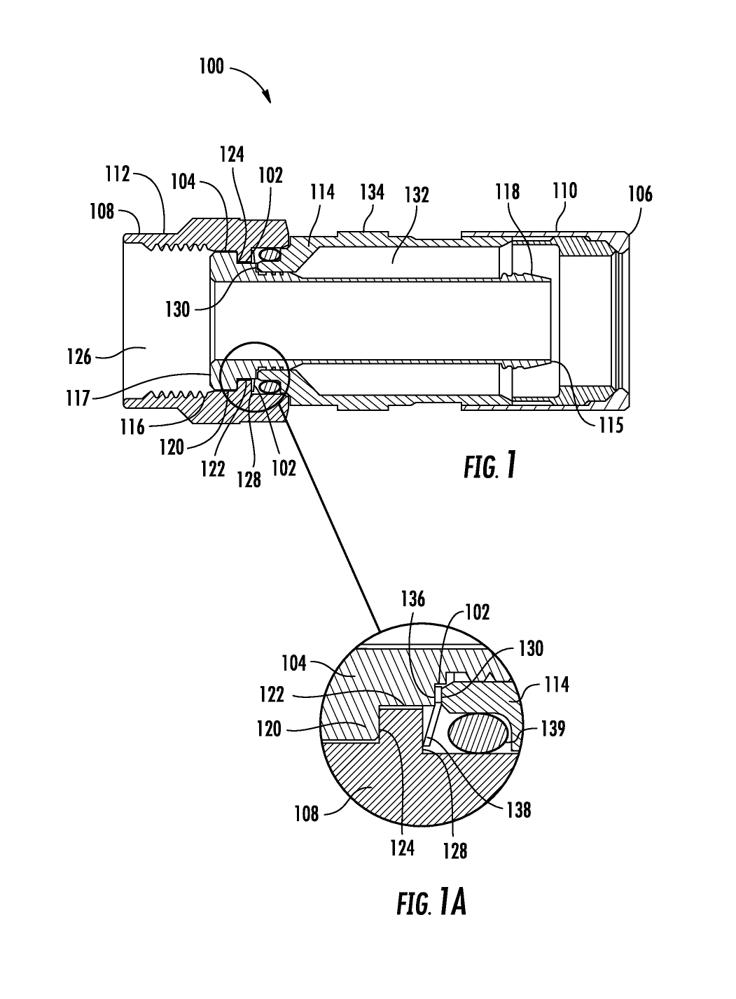

In this regard, FIGS. 1 and 1A illustrates an exemplary embodiment of coaxial cable connector 100 known in the art having a shield 102 to provide a stable ground path and protect against the ingress of RF signals. Although, the coaxial connector 100 in FIG. 1 is an axial-compression type coaxial connector having a tubular post 104, the shield 102 may be incorporated any type of coaxial connector, examples of which will be discussed herein. The coaxial cable connector 100 is shown in its unattached, uncompressed state, without a coaxial cable inserted therein. The coaxial cable connector 100 couples a prepared end of a coaxial cable to a threaded female equipment connection port (not shown in FIG. 1). This will be discussed in more detail with reference to FIG. 4. The coaxial cable connector 100 has a first end 106 and a second end 108. A shell 110 slidably attaches to the coaxial cable connector at the first end 106. A coupler 112 attaches to the coaxial cable connector 100 at the second end 108. The coupler 112 may rotatably attach to the second end 108, and, thereby, also to the tubular post 104. The shield 102 is disposed between the tubular post 104, the coupler 112 and a body 114 of the coaxial connector 100. In this way, the shield 102 provides an electrically conductive path between the body 114, the tubular post 104, and the coupler 112. This enables an electrically conductive path from the coaxial cable through the coaxial cable connector 100 to the equipment connection port providing shielding against RF ingress and grounding.

Continuing with reference to FIGS. 1 and 1A, the tubular post 104 has a first end 115 which is adapted to extend into a coaxial cable and a second end 117. An enlarged shoulder 116 at the second end 117 extends inside the coupler 112. At the first end 115, the tubular post 104 has a circular barb 118 extending radially outwardly from the tubular post 104. The enlarged shoulder 116 comprises a first rearward facing annular shoulder 120, and a stepped diameter leading to a second rearward facing annular shoulder 122. The coupler 112 comprises a forward facing annular surface 124, a through-bore 126 and a rearward facing annular surface 128. The body 114 at least partially comprises a face 130, a through bore 132 and an external annular surface 134. An inner segment 136 of the shield 102 is disposed between the second rearward facing annular shoulder 122 of the tubular post 104 and face 130 of the body 114. In this manner, the shield 102 is captured and secured in the coaxial cable connector 100, and establishes an electrically conductive path between the body 114 and the tubular post 104. Further, the shield 102 is and remains captured and secured independent of the tightness of the coaxial cable connector 100 on the appliance equipment connection port. In other words, the shield 102 remains secured and the electrically conductive path remains established between the body 114 and the tubular post 104 even when the coaxial cable connector is loosened and/or disconnected from the appliance equipment connection port. Additionally, the shield 102 has resilient and flexible cantilevered annular beams 138 disposed against the rearward facing annular surface 128 of the coupler 112. In this manner, the cantilevered annular beams 138 maintain contact with the coupler independent of tightness of the coaxial cable connector 100 on the appliance equipment connection port without restricting the movement, including the rotation of the coupler 112. The coaxial cable connector 100 may also include a sealing ring 139 seated within the coupler 112 to form a seal between the coupler 112 and the body 114.

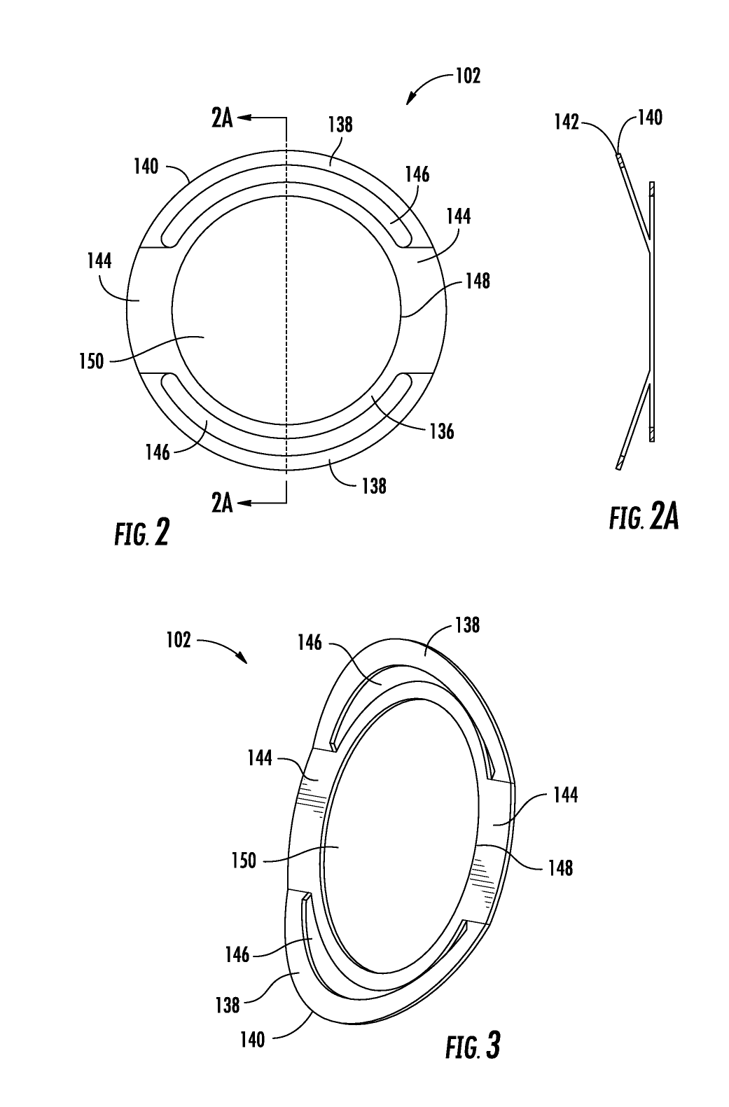

Referring now to FIGS. 2 and 2A, the shield 102 may be circular with the inner segment 136 and at least one pre-formed cantilevered annular beam 138. Additionally, the shield 102 may have a plurality of pre-formed cantilevered annular beams 138. The least one pre-formed cantilevered annular beam 138 is flexible, arcuately shaped and extends at approximately a 19° angle from the plane of the inner segment 136. The pre-formed cantilevered annular beam 138 has an outer surface 140 with an edge 142, as shown in FIG. 2A. Joining segments 144 join the plurality of the pre-formed cantilevered annular beams 138 to the inner segment 136 forming a plurality of slots 146 therebetween. The inner segment 136 has an inner surface 148 that defines a central aperture 150. Shield 102 may be made from a metallic material, including as a non-limiting example, phosphor bronze, and have a width of approximately 0.005 inches. Additionally or alternatively, the shield 102 may be un-plated or plated with a conductive material, as non-limiting examples tin, tin-nickel or the like.

Referring now also to FIG. 3, the shield 102 is illustrated in a perspective view to further illustrate the components including the pre-formed cantilevered annular beams 138. Pre-forming the cantilevered annular beams 138 as illustrated in FIGS. 2A and 3, provides the technical advantage of improved application of the material properties of the shield 102 to provide a spring force biasing the edge 142 toward the rearward facing annular surface 140 and causing the edge 142 of outer surface 140 to intimately contact rearward facing annular surface 128 of the coupler 112. Because of this, the shield 102 may be manufactured without having to utilize a more expensive material such as beryllium copper. Additionally, the material of the shield 102 does not need to be heat treated. Further, the natural spring-like qualities of the selected material are utilized, with the modulus of elasticity preventing the shield 102 from being over-stressed by providing for limited relative axial movement between coupler 112, the tubular post 104 and the body 114.

Electrical grounding properties are enhanced by providing an arcuately increased area of surface engagement between the edges 142 of the cantilevered annular beams 138 and rearward facing annular surface 128 of coupler 112 as compared, for example, to the amount of surface engagement of individual, limited number of contact points, such as raised bumps and the like. In this manner, the increased area of surface engagement provides the opportunity to engage a greater number of Asperity spots (“A-spots”) rather than relying on the limited number of mechanical and A-spot points of engagement. Additionally, the edge 142 may have a knife-like sharpness. Thus, the knife-like sharpness of the edge 142 makes mechanical contact between the cantilevered annular beams 138 and rearward facing annular surface 128 of coupler 112 without restricting the movement of the coupler 112. Also, the knife-like sharpness of the edge 142 and the plating of shield 102 provide a wiping action of surface oxides to provide for conductivity during periods of relative motion between the components.

Moreover, in addition to the increased number of A-spot engagement, the increased area of surface engagement results in an increased area of concentrated, mechanical pressure. While providing the degree of surface contact and concentrated mechanical force, the shield 102 does not negatively impact the “feel” of coupler rotation due to the limited amount of frictional drag exerted by the profile of edges 142 against reward facing annular surface 128. Mechanically and conductively capturing shield 102 between tubular post 104 and body 114 obviates the need for any flanges and, thus, simplifies the tooling necessary to produce the shield 102 resulting in a cost savings in manufacture.

The shield 102 is resilient relative to the longitudinal axis of the coaxial cable connector 100 and maintains an arcuately increased surface of sliding electrical contact between shield 102 and the rearward facing annular surface 128 of the coupler 112. At the same time the shield is firmly captured and grounded between the body 114 and the tubular post 104 providing assured electrical and mechanical communication between the coupler 106, the body 114 and the tubular post 104 while allowing smooth and easy rotation of the coupler 112.

Referring now to FIG. 4, the coaxial cable connector 100 is shown with a coaxial cable 200 inserted therein. The shell 106 has a first end 152 and an opposing second end 154. The shell 106 may be made of metal. A central passageway 156 extends through the shell 106 between first end 152 and the second end 154. The central passageway 156 has an inner wall 158 with a diameter commensurate with the outer diameter of the external annular surface 134 of the body 112 for allowing the second end 154 of the shell 106 to extend over the body 112. A gripping ring or member 160 (hereinafter referred to as “gripping member”) is disposed within the central passageway 156 of the shell 106. The central passageway 156 proximate the first end 152 of shell 106 has an inner diameter that is less than the diameter of the inner wall 158.

The coaxial cable 200 has center conductor 202. The center conductor 202 is surrounded by a dielectric material 204, and the dielectric material 204 is surrounded by an outer conductor 206 that may be in the form of a conductive foil and/or braided sheath. The outer conductor 206 is usually surrounded by a plastic cable jacket 208 that electrically insulates, and mechanically protects, the outer conductor. A prepared end of the coaxial cable 200 is inserted into the first end 106 of the coaxial cable connector 100. A compression tool (not shown) is used to feed the coaxial cable 200 into the coaxial cable connector 100 such that the circular barb 118 of the tubular post 104 inserts between the dielectric material 204 and the outer conductor 206 of the coaxial cable 200, making contact with the outer conductor 206. The compression tool also advances the shell 106 toward the coupler 112. As the shell 106 is advanced over the external annular surface 134 of the body 114 toward the coupler 112, the reduced diameter of the central passageway 156 causes the gripping member 160 to compress against the cable jacket 208. In this manner, the coaxial cable 200 is retained in the coaxial cable connector 100. Additionally, the circular barb 118 positioned between the dielectric material 204 and the outer conductor 206 acts to maximize the retention strength of the cable jacket 202 within coaxial cable connector 100. As the shell 106 moves toward the second end of the coaxial cable connector 100, the shell 106 causes the gripper member 160 to compress the cable jacket 202 such that the cable jacket 202 is pinched between the gripper member 160 and the circular barb 118 increasing the pull-out force required to dislodge cable 200 from coaxial cable connector 100. Since the outer conductor 206 is in contact with the tubular post 104 an electrically conductive path is established from the outer conductor 206 through the tubular post 104 to the shield 102 and, thereby, to the coupler 112.

Further, the shield 102 is and remains captured and secured and the electrically-conductive path remains established independent of the tightness of the coaxial cable connector 100 on the appliance equipment connection port. In other words, the shield 102 remains secured and the electrically conductive path remains established between the body 114 and the tubular post 104 even when the coaxial cable connector is loosened and/or disconnected from the appliance equipment connection port. Additionally, the shield 102 has resilient and flexible cantilevered annular beams 138 disposed against the rearward facing annular surface 128 of the coupler 112. In this manner, the cantilevered annular beams 138 maintain contact with the coupler independent of tightness of the coaxial cable connector 100 on the appliance equipment connection port without restricting the movement, including the rotation of the coupler 112.

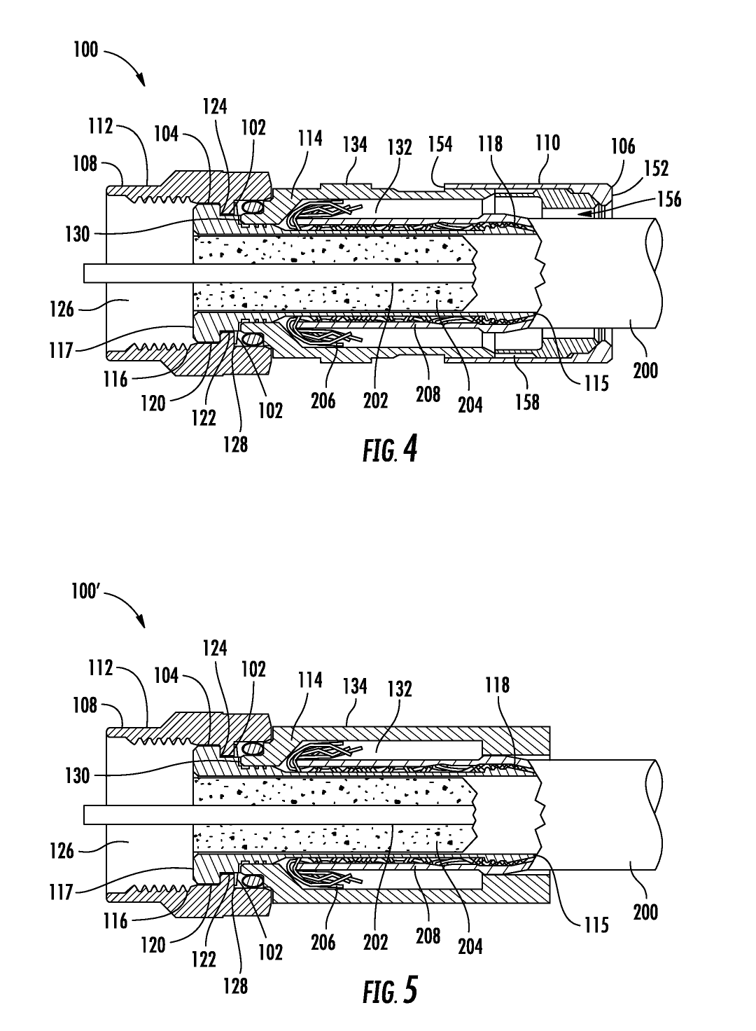

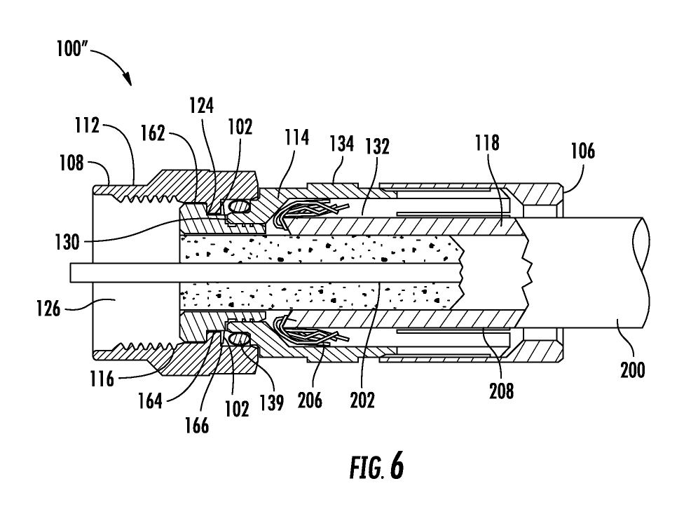

Referring now to FIG. 5, there is shown the shield 102 disposed in another coaxial cable connector 100′ known in the art with the coaxial cable 200 inserted therein. In FIG. 5, the coaxial cable connector 100′ is not a compression type. The prepared end of the coaxial cable 200 inserts into the first end 106 of the coaxial cable connector 100′ and the tubular post 104 inserts into the prepared end coaxial cable 200 in a similar manner as described above with reference to FIG. 4. However, instead of having a gripping member as shown in FIG. 4, the compression tool (not shown) forces the tubular post 104 to slide (to the left in the drawings) relative to the other components in the coaxial cable connector 100′. This results in the second rearward facing annular shoulder 122 of the tubular post 104 to move toward the face 130 of the body 114 such that the tubular post 104 and the body 114 meet at the inner segment 136 and apply compressive pressure on both sides of the inner segment 136. In this manner, the shield 102 is captured and secured in the coaxial cable connector 100′, and establishes an electrically conductive path between the body 114 and the tubular post 104 as described above with reference to FIGS. 1 and 1A. Further, the shield 102 is and remains captured and secured and the electrically-conductive path remains established independent of the tightness of the coaxial cable connector 100′ on the appliance equipment connection port. In other words, the shield 102 remains secured and the electrically conductive path remains established between the body 114 and the tubular post 104 even when the coaxial cable connector 100′ is loosened and/or disconnected from the appliance equipment connection port. Additionally, the shield 102 has resilient and flexible cantilevered annular beams 138 disposed against the rearward facing annular surface 128 of the coupler 112. In this manner, the cantilevered annular beams 138 maintain contact with the coupler 112 independent of tightness of the coaxial cable connector 100′ on the appliance equipment connection port without restricting the movement, including the rotation of the coupler 112.

Referring now to FIG. 6, there is shown the shield 102 in another coaxial cable connector 100″ known in the art. The coaxial cable connector 100″ shown in FIG. 6 is a post-less coaxial cable connector. The prepared end of the coaxial cable 200 inserts into the first end 106 of the coaxial cable connector 100″. However, instead of a tubular post inserting between the dielectric material 204 and the outer conductor 206, the prepared end of the coaxial cable 200 extends to a collar 162. The collar 162 comprises a first rearward facing annular shoulder 164, and a stepped diameter leading to a second rearward facing annular shoulder 166. In a similar manner as described above, the inner segment 136 of the shield 102 is disposed between the second rearward facing annular shoulder 166 of the collar 162 and the face 130 of the body 114. In this manner, the shield 102 is captured and secured in the coaxial cable connector 100″, and establishes an electrically conductive path between the body 114 and the collar 162. Further, the shield 102 is and remains captured and secured and the electrically-conductive path remains established independent of the tightness of the coaxial cable connector 100″ on the appliance equipment connection port. In other words, the shield 102 remains secured and the electrically conductive path remains established between the body 114 and the collar 162 even when the coaxial cable connector is loosened and/or disconnected from the appliance equipment connection port. Additionally, the shield 102 has resilient and flexible cantilevered annular beams 138 disposed against the rearward facing annular surface 128 of the coupler 112. In this manner, the cantilevered annular beams 138 maintain contact with the coupler 112 independent of tightness of the coaxial cable connector 100″ on the appliance equipment connection port without restricting the movement, including the rotation of the coupler 112.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An RFI and grounding shield for a coaxial cable connector, comprising:
a circular inner segment;
at least one pre-formed cantilevered annular beam attached to the circular inner segment and angularly extending from a plane of the circular inner segment, wherein the circular inner segment and the at least one pre-formed cantilevered annular beam applies a spring-force to a surface of one of the components establishing an electrically conductive path between components of the coaxial cable connector when positioned in the coaxial cable connector.

2. The shield of claim 1, wherein the at least one pre-formed cantilevered annular beam is arcuately shaped.

3. The shield of claim 1, wherein the at least one pre-formed cantilevered annular beam comprises an outer surface with an edge, and wherein the edge has a knife-like sharpness and provides a wiping action of surface oxides on component surfaces of the coaxial cable connector.

4. The shield of claim 1, wherein the circular inner segment and the at least one pre-formed cantilevered annular beam are metallic.

5. The shield of claim 4, wherein the circular inner segment and the at least one pre-formed cantilevered annular beam are formed of phosphor bronze.

6. The shield of claim 1, further comprising a conductive material plating.

7. The shield of claim 6, wherein the conductive material plating is one of tin and tin-nickel.

8. The shield of claim 1, wherein the at least one pre-formed cantilevered annular beam comprises a plurality of pre-formed cantilevered annular beams.

9. The shield of claim 1, wherein the components comprise a coupler, a tubular post and a body.

10. The shield of claim 9, wherein the inner segment is disposed between the tubular post and the body.

11. The shield of claim 9, wherein the at least one pre-formed cantilevered annular beam exerts a spring-like force on a surface of the coupler.

12. A coaxial cable connector for coupling a coaxial cable to an equipment port, the coaxial cable including a center conductor surrounded by a dielectric material, the dielectric material being surrounded by an outer conductor, the coaxial cable connector comprising in combination:
a tubular post having a first end adapted to be inserted into the prepared end of the coaxial cable between the dielectric material and the outer conductor, and having a second end opposite the first end thereof;
a coupler having a first end rotatably secured over the second end of the tubular post, and having an opposing second end, the coupler including a central bore extending therethrough, a portion of the central bore proximate the second end of the coupler being adapted for engaging the equipment port;
a body secured to the tubular post and extending about the first end of the tubular post for receiving the outer conductor of the coaxial cable, wherein the body member contacts the coupler;
a resilient, electrically-conductive shield having a inner segment and at least one pre-formed cantilevered annular beam attached to the inner segment, wherein the inner segment is disposed between the tubular post and the body, and the at least one pre-formed cantilevered annular beam exerts a spring-like force on the coupler, and wherein the shield provides an electrically-conductive path between the tubular post and the coupler, and wherein the shield remains captured and secured and provides the electrically-conductive path independent of the tightness of the coaxial cable connector.

13. The coaxial cable connector of claim 12, wherein the shield is generally circular and the at least one pre-formed cantilevered annular beam is arcuately shaped.

14. The coaxial cable connector of claim 12, wherein the second end of the tubular post has an enlarged shoulder comprising a first rearward facing annular shoulder and a second rearward facing annular shoulder.

15. The coaxial cable connector of claim 14, wherein the inner segment is positioned between a face of the body and the second rearward facing annular shoulder thereby securing the shield in the coaxial cable connector by the inner segment.

16. The coaxial cable connector of claim 12, wherein the coupler comprises a rearward facing annular surface, and wherein the at least one pre-formed cantilevered annular beam exerts a spring-like force on the coupler at the rearward facing annular surface.

17. The coaxial cable connector of claim 14, wherein the shield is resilient relative to the longitudinal axis of the connector and maintains an acurately increased surface of sliding electrical contact between the shield and the rearward facing annular surface of the coupler.

18. The coaxial cable connector of claim 12, wherein the at least one pre-formed cantilevered annular beam comprises an outer surface with an edge, and wherein the edge has a knife-like sharpness and provides a wiping action of surface oxides on a surface of the coupler.

19. The coaxial cable connector of claim 12, wherein the shield provides for unrestricted rotation of the coupler.

20. The coaxial cable connector of claim 12, wherein the shield maintains the electrically conductive path between the coaxial cable conductor and an equipment connection port of an appliance when the coupler is loosened from while in contact with the equipment connection port.
